(19) United States
(12) Patent Application Publication
(10) Pub. No.: US 2011/0222579 A1
(43) Pub. Date: Sep. 15, 2011

(54) Motion Powered Thermometer

(75) Inventor: Chu-Yih Yu, Taipei Hsien (TW)

(73) Assignee: MESURE TECHNOLOGY CO., LTD., San Chung City (TW)

(21) Appl. No.: 12/819,610

(22) Filed: Jun. 21, 2010

(30) Foreign Application Priority Data
Mar. 9, 2010 (TW) 099204190

(51) Int. Cl. G01K 1/00

(52) U.S. Cl. 374/152; 374/E01.001

(57) ABSTRACT

A motion powered thermometer is constituted by a body member and a tip member with a thermal contact surface secured to the body member. A thermal sensor mounted on the inside of the tip member is adapted for sensing a thermal contact surface and producing a temperature signal. A set of leas wires is coupled to the thermal sensor for transmission of the temperature signal. A tubular cylinder is disposed in the body member and a magnetic core is free to slide within the tubular cylinder. A coil of wire is wrapped around the tubular cylinder so that the magnetic core moves through the coil of wire when sliding through the tubular cylinder from one end to an opposite end. A capacitor is electrically connected to the coil of wire. A processor is electrically connected to the capacitor and the set of lead wires.

### BACKGROUND OF THE INVENTION

1. Field of the Invention

The invention relates to the field of thermometers, and more particularly to the field of motion powered thermometers.

2. Description of the Related Art

Electronic thermometers generally offer a great number of advantages over conventional glass and mercury thermometers for use in the health care field. Among the advantages of electronic thermometers are the elimination of sterilization procedures for glass thermometers, made possible by the use of disposable covers; elimination of the possibility of broken glass if a thermometer is dropped; a digital temperature display to eliminate temperature reading errors; and with proper circuit design and calibration, higher accuracy and resolution is possible with accurate measurement and display of tenths of a degree Fahrenheit being easily attainable.

Such electronic thermometers typically use a chemical battery as a power supply. However, the electronic thermometers are generally idle for a long time since patients only use the electronic thermometers while they are sick or feel uncomfortable. Thus such electronic thermometers employing a chemical battery as a power supply are not environmentally friendly.

### SUMMARY OF THE INVENTION

An exemplary embodiment of the present invention overcomes the above-described problems by providing a motion powered thermometer is constituted by a body member and a tip member with a thermal contact surface secured to the body member. A thermal sensor mounted on the inside of the tip member is adapted for sensing the thermal contact surface and producing a temperature signal. A set of leas wires is coupled to the thermal sensor for transmission of the temperature signal. A tubular cylinder is disposed in the body member and a magnetic core is free to slide within the tubular cylinder. A coil of wire is wrapped around the tubular cylinder so that the magnetic core moves through the coil of wire when sliding through the tubular cylinder from one end to an opposite end. A capacitor is electrically connected to the coil of wire, serving as a motion electric power generator. A processor is electrically connected to the motion electric power generator and the set of lead wires.

### DESCRIPTION OF THE DRAWINGS

The present invention will be described by way of exemplary embodiments, but not limitations, illustrated in the accompanying drawings in which like references denote similar elements, and in which:

FIG. 1 is a schematic view of a motion powered thermometer according to an exemplary embodiment of the invention; and

FIG. 2 is an exploded perspective view of a motion powered thermometer according to an exemplary embodiment of the invention.

FIG. 3 is a schematic view of a motion electric power generator according to an exemplary embodiment of the invention

### DETAILED DESCRIPTION OF THE INVENTION

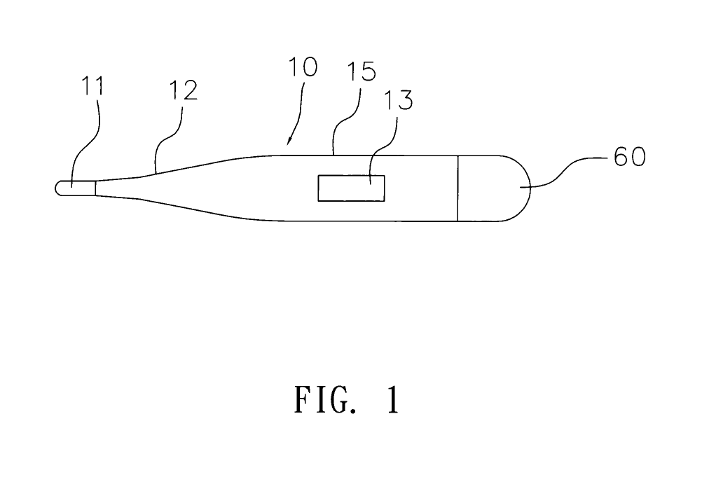

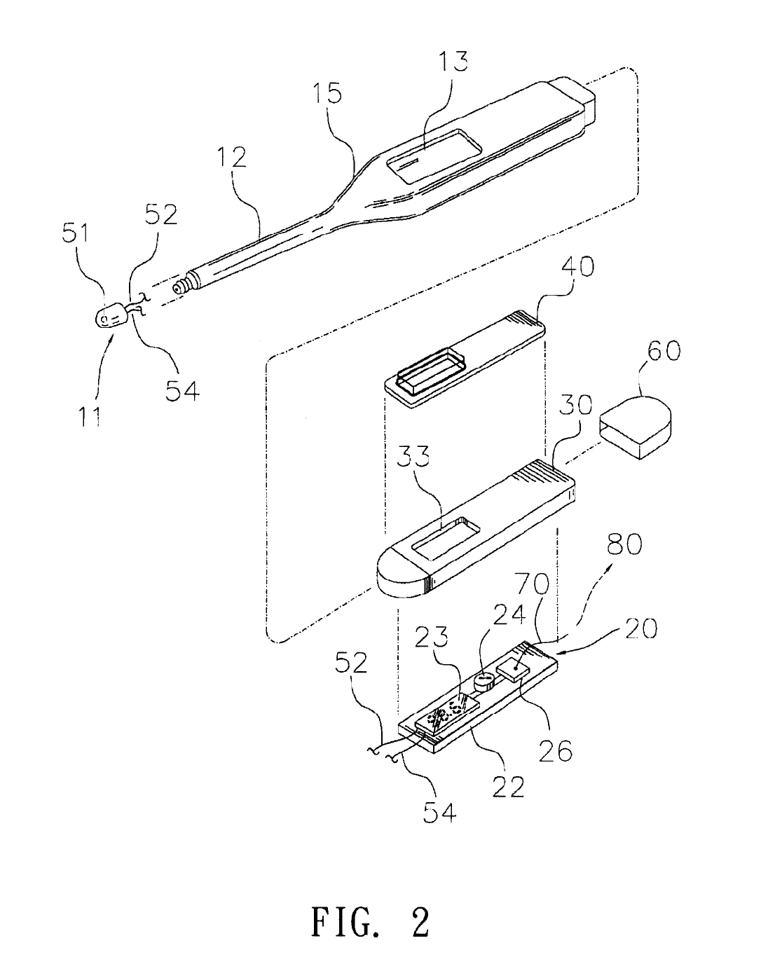

Referring to FIGS. 1 and 2, an embodiment of a thermometer is illustrated. The thermometer is made up of a body member 10 and a tip member 11. Typically, a cover 60 is secured to the body member 10 after components of the thermometer have been assembled. The body member 10 includes a probe portion 12 and a display portion 15. The tip member 11 is secured to the probe portion 12 of the body member 10. Preferably, it contains a thermal contact surface surrounding a hollow cavity. In one embodiment, the hollow tip member 11 is preferably made of metal with good thermal conductivity, such as stainless steel.

A thermal sensor 51 is placed at the end of the tip member 11 and mounted on the inside of the thermal contact surface. The thermal sensor senses the temperature of the thermal contact surface and produces a temperature signal. There are a set of lead wires 52, 54 coupled to the thermal sensor 51 for transmission of the temperature signal.

As shown in FIG. 2, a display unit 20 is disposed in the display portion 15 and connected to the lead wires 52, 54 to receive the temperature signal for display of a corresponding temperature reading. Typically, a base plate 30 may be adapted for supporting the display unit 20. In one example, the display unit 20 may comprise a substrate 22; a display 23, such as LCD panel, disposed thereon; and a processor 24 such as integrated circuit chip disposed thereon, coupled to the display 23. Processor 24 is electrically connected to the lead wires 52, 54 to receive the temperature signal; it drives the display 23 to show a corresponding temperature reading. Preferably, the base plate 30 has an opening 33 to expose the display 23. Typically, the base plate 30 is plastic and the substrate 22 is PCB board.

In one example, the tip member 11 is made in the form of a tubular shape and closed at a domed, hemispherical or hemiellipsoid shaped end. The contact surface is brought in contact with flesh of a patient so that heat can be transferred from the patient's flesh to the tip member 11. In one embodiment, the thermal sensor 51 is thermistor. The lead wires 52, 54 and the thermistor 51 are both adhered on the inside of the thermal contact surface with heat conductive glue. The glue is an insulating material with good thermal conductivity, e.g., epoxy resin. Moreover, the lead wires 52, 54 are made up of a pair of electrical lead wires; they are used to connect the thermal sensor 51 to the processor 24 for determining a corresponding temperature to display.

A transparent layer 40 extending from an upper surface thereof at least covers the display unit 20 under the display aperture 13. Preferably, the transparent layer 40 covers an entire upper surface of the base plate 30. And generally, the display 23 is disposed on the substrate 22 and under the transparent layer 40. The transparent layer 40 may be a transparent plastic sheet. Preferably, the transparent layer is made of organic glass or polymethyl methacrylate (PMMA).

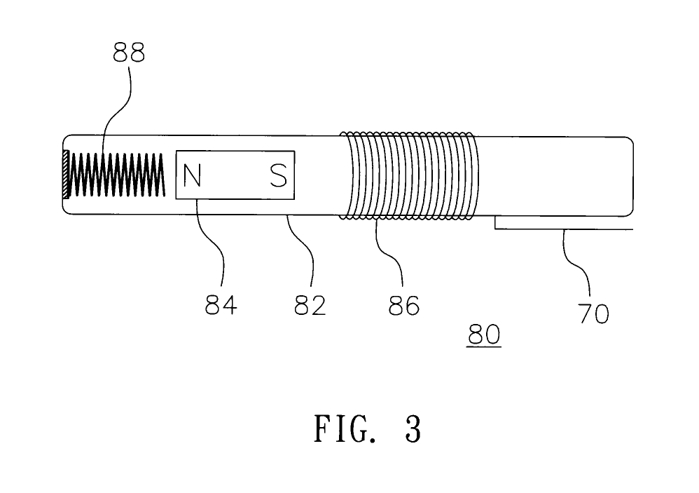

Referring to FIG. 3, a motion electric power generator 80 is disposed in the body member 10, in one example, adjacent to display unit 20. Motion electric power generator 80 comprises a tubular cylinder 82 disposed in the body member and a magnetic core 84 being free to slide within the tubular cylinder 82. A coil of wire 86 is wrapped around the tubular cylinder 82 so that the magnetic core 84 moves through the coil of wire 86 when sliding through the tubular cylinder 82 from one end to an opposite end. As shown in FIG. 2, a capacitor 26 such as chip capacitor to be charged is electrically connected to the coil of wire 86 through the electricity transmission wires 70. As magnetic core 84 moves through tubular cylinder 82, it will change the magnet flux flowing through the coil of wire 86, increasing the capacitor voltage.

Further, processor 24 is electrically connected to the capacitor 26 to obtain electric power and is electrically connected to the set of lead wires 52, 54 to receive the temperature signal and drive the display unit for display of a corresponding temperature reading. In one example, capacitor 26 stores electrical energy by continuously moving the thermometer back and forth. Processor 24 is actuated to drive the display 23 to display a starting signal showing the thermometer is performing a charging action or transmit the starting signal to a speaker (not shown) to generate voice to inform the user the thermometer is performing a charging action, while the capacitor voltage is equal to or higher than a predetermined start voltage. And then the processor 24 is detecting a change of the capacitor voltage. During a short motion time, processor 24 starts it's body temperature measuring operation and drive the display 23 to display an operation signal showing the thermometer is performing a body temperature measuring operation or transmit the operation signal to a speaker (not shown) to generate voice to inform the user the thermometer is performing a body temperature measuring operation, while the capacitor voltage is further increased to a predetermined operation voltage and which is enough to perform at least one or two cycles of body temperature measuring operation.

In such thermometers, capacitor stores energy for the processor to use on demand, so it can be used like a temporary battery to maintain power supply. Thus, there is no need to use a chemical battery which is easy to cause environmental pollution.

Furthermore, a helical spring 88 may be mounted on one end or both ends of the tubular cylinder 82 to increase the movement of the magnetic core 84.

In another embodiment, there is no need to create battery cover and/or power switch on the surface of the body potion of the thermometers since the thermometers are battery free, and thus such structure may enhance a water-tight seal function as shown in FIG. 1.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A motion powered thermometer comprising:
a body member and a tip member with a thermal contact surface secured to the body member;
a thermal sensor mounted on the inside of the tip member, adapted for sensing the thermal contact surface and producing a temperature signal;
a set of leas wires, coupled to the thermal sensor for transmission of the temperature signal;
a display unit;
a tubular cylinder, disposed in the body member;
a magnetic core, being free to slide within the tubular cylinder;
a coil of wire, wrapped around the tubular cylinder so that the magnetic core moves through the coil of wire when sliding through the tubular cylinder from one end to an opposite end;
a capacitor, electrically connected to the coil of wire; and
a processor, electrically connected to the capacitor to obtain electric power and electrically connected to the set of lead wires to receive the temperature signal and drive the display unit for display of a corresponding temperature reading.

2. The thermometer as recited in claim 1 further comprising a substrate and wherein the display unit, the processor and the capacitor are disposed on the substrate.

3. The thermometer as recited in claim 2 wherein the processor comprises an integrated circuit chip.

4. The thermometer as recited in claim 3 wherein the capacitor comprises a chip capacitor.

5. The thermometer as recited in claim 1 further comprising a helical spring mounted on one end or both ends of the tubular cylinder.

6. The thermometer as recited in claim 1, wherein the capacitor stores electrical energy by moving the thermometer back and forth, and the processor is actuated to detect a change of the capacitor voltage while a capacitor voltage is equal to or higher than a predetermined start voltage.

7. The thermometer as recited in claim 6, wherein the processor is actuated to drive the display unit to display a starting signal showing the thermometer is performing a charging action.

8. The thermometer as recited in claim 7, wherein the processor starts a body temperature measuring operation and drives the display unit to display an operation signal showing the thermometer is performing a body temperature measuring operation, while the capacitor voltage is further increased to an operation voltage which is enough to perform at least a cycle of the body temperature measuring operation.

9. A motion powered thermometer comprising:
a body member and a tip member with a thermal contact surface secured to the body member;
a thermal sensor mounted on the inside of the tip member, adapted for sensing the thermal contact surface and producing a temperature signal;
a set of leas wires, coupled to the thermal sensor for transmission of the temperature signal;
a tubular cylinder, disposed in the body member;
a magnetic core, being free to slide within the tubular cylinder;
a coil of wire, wrapped around the tubular cylinder so that the magnetic core moves through the coil of wire when sliding through the tubular cylinder from one end to an opposite end;
a capacitor, electrically connected to the coil of wire, serving as a motion electric power generator; and
a processor, electrically connected to the motion electric power generator and the set of lead wires.
